(19) United States
(12) Patent Application Publication
(10) Pub. No.: US 2006/0009250 A1
(43) Pub. Date: Jan. 12, 2006

(54) Apparatus and method for determining access power in a mobile communication system

(75) Inventors: Jae-Hyok Lee, Seoul (KR); Sung-Kwon Jo, Suwon-si (KR); Dong-Keon Kong, Suwon-si (KR); Seung-Il Yoon, Seongnam-si (KR); In-Ky Cho, Yongin-si (KR); Jae-Ho Jeon, Seongnam-si (KR); Ji-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/178,497

(22) Filed: Jul. 12, 2005

(30) Foreign Application Priority Data
Jul. 12, 2004 (KR) 2004-54166

(51) Int. Cl. H04Q 7/20

(52) U.S. Cl. 455/522; 455/69

(57) ABSTRACT

An apparatus and method for determining access power in a mobile communication system. The system includes a base transceiver station (BTS) for generating and transmitting a message field including access parameter information and BTS load information within an area covered by the BTS, and the mobile terminal for determining transmission power for access on a basis of power of a signal received from the BTS and the message field. The method includes the steps of generating a message field including access parameter information and BTS load information and transmitting the message field from the BTS to the mobile terminal within an area covered by the BTS, and determining transmission power for access in the mobile terminal on a basis of power of a signal received from the BTS and the message field.

### PRIORITY

This application claims the benefit under 35 U.S.C. § 119(a) to an application entitled “Apparatus and Method for Determining Access Power in a Mobile Communication System” filed in the Korean Intellectual Property Office on Jul. 12, 2004 and assigned Serial No. 2004-54166, the entire contents of which are incorporated herein by reference.

### BACKGROUND OF THE INVENTION

1. Field of the Invention

The present invention generally relates to power control in a mobile communication system. More particularly, the present invention relates to an apparatus and method for determining access power in a mobile communication system.

2. Description of the Related Art

In a mobile communication system, a procedure for accessing a base transceiver station (BTS) from a mobile terminal significantly influences a call setup time. Specifically, the access procedure may vary the call setup time according to how fast the BTS detects an access signal from a mobile terminal in a code division multiple access (CDMA) mobile communication system.

In the access procedure adopted in the CDMA system, mobile terminals attempt random access to a BTS. In this case, collision between access signals transmitted from the mobile terminals may occur. When the BTS does not detect an access signal due to the collision and the mobile terminal does not receive acknowledge (ACK) from the BTS, the mobile terminal re-performs the access procedure.

When the probability of detecting an access signal of a mobile terminal in the BTS is high, a total call setup time can be reduced. To increase the probability of detecting an access signal, the mobile terminal can transmit the access signal at high power.

However, because the access signal transmitted at the high power serves as interference to traffic signals of other mobile terminals in the CDMA system, the overall system capacity may be reduced. Because a connected call is cut off in a severe case, it is difficult to increase only the access signal power.

To increase the probability of detecting an access signal in the current CDMA system, a widely used scheme is open loop power control. In the open loop power control scheme, the mobile terminal measures the power of a signal received from the BTS and determines the output power of an access signal on the basis of a value of the measured power. This scheme assumes that correlation of downlink and uplink channels between the BTS and the mobile terminal is high, and sets the power of an access signal after measuring the power of a signal received from the BTS and estimating the path loss.

In the conventional CDMA system, the mobile terminal measures the power of a broadcasting signal received from the BTS before transmitting an access signal, compensates access parameter information broadcast from the BTS using a value of the measured power, and determines the transmission power for access.

In case of a 1× system, the mobile terminal transmits an access signal at a mean output power computed by Equation (1):
mean output power (dBm)=−mean input power (dBm)+INIT_{—}PWRs Equation (1)

In Equation (1), ‘mean input power’ is a measure of received power at the mobile terminal, and ‘INIT_PWRs’ is a value broadcast by the BTS.

In case of a DO system, a power compensation value transmitted from the BTS is denoted by ‘Open Loop Adjust’, and the mobile terminal determines the transmission power as shown in Equation (2):
mean output power (dBm)=−Mean Received Power (dBm)+Open Loop Adjust Equation (2)

In Equation (2), ‘Mean Received Power’ is a measure of the received power at the mobile terminal, and ‘Open Loop Adjust’ is a value broadcast by the BTS.

When the BTS detects an access signal in the open loop power control mode, the access signal detection depends upon the power of signals received from mobile terminals at the BTS as well as path loss between the mobile terminal and the BTS. That is, even though the mobile terminal increases the transmission power of the access signal, a serving BTS may not detect the access signal when BTS load is high. The mobile terminal desiring to make an access attempt must consider the power of all signals currently being received by the BTS as well as the path loss associated with the BTS when determining the suitable transmission power of an access signal.

However, because the conventional method does not consider the BTS load or a target signal to noise ratio (SNR) of the BTS, an access signal may fail to be detected according to the amount of BTS load or the target SNR of the BTS. That is, even when the mobile terminal transmits an access signal to which a predetermined gain is assigned while considering path loss on the basis of a power level of a signal received from the BTS, the access signal may not be detected if the BTS load is high and therefore a call setup time is lengthened.

### SUMMARY OF THE INVENTION

It is, therefore, an aspect of the present invention to provide an apparatus and method for efficiently performing a call setup process in a mobile communication system for performing power control.

It is another aspect of the present invention to provide an apparatus and method for determining transmission power for access by additionally using load information of a base transceiver station (BTS) in open loop power control mode in a mobile communication system for performing power control.

The above and other aspects of the present invention can be achieved by a mobile communication system for performing power control, comprising a base transceiver station (BTS) for generating and transmitting a message field including access parameter information and BTS load information within an area covered by the BTS; and a mobile terminal for determining transmission power for access on a basis of power of a signal received from the BTS and the message field.

The BTS comprises a received power measurer for measuring power received from all mobile terminals; a controller for computing the BTS load information using the measured received power; a message generator for generating the message field comprising the BTS load information; and a transmitter for transmitting the message field to the mobile terminal.

The mobile terminal comprises a received power measurer for measuring received power of a signal transmitted from the BTS; a message receiver for detecting the access parameter information and the BTS load information from the message field transmitted by the BTS; a controller for computing transmission power for access on a basis of information sent from the received power measurer and the message receiver; and a transmitter for accessing the BTS at the computed transmission power for access.

The controller additionally considers BTS transmission power information and computes the transmission power for access.

The above and other aspects of the present invention can also be achieved by a method for performing power control between a base transceiver station (BTS) and a mobile terminal in a mobile communication system, comprising the steps of (a) generating a message field comprising access parameter information and BTS load information and transmitting the message field from the BTS to the mobile terminal within an area covered by the BTS; and (b) determining transmission power for access in the mobile terminal on a basis of power of a signal received from the BTS and the message field.

The step (a) comprises the steps of measuring power received from all mobile terminals; computing the BTS load information using the measured received power; generating the message field comprising the BTS load information; and transmitting the message field to the mobile terminal.

The step (b) comprises the steps of measuring received power of a signal transmitted from the BTS; detecting the access parameter information and the BTS load information from the message field transmitted by the BTS; computing transmission power for access on a basis of information sent from the received power measurer and the message receiver; and accessing the BTS at the computed transmission power for access.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a structure of a mobile communication system for determining access power in a mobile terminal in accordance with an embodiment of the present invention;

FIG. 2 is a signal flow diagram illustrating a method for determining access power in the mobile terminal in accordance with an embodiment of the present invention;

FIG. 3 is a signal flow diagram illustrating a first method for determining access power in the mobile terminal in accordance with an embodiment of the present invention;

FIG. 4 is a signal flow diagram illustrating a second method for determining access power in the mobile terminal in accordance with an embodiment of the present invention;

FIG. 5 is a block diagram illustrating a structure of a base transceiver station (BTS) in accordance with an embodiment of the present invention;

FIG. 6 is a flow chart illustrating a method for generating and transmitting an access parameter in a base transceiver station (BTS) in accordance with an embodiment of the present invention;

FIG. 7 is a block diagram illustrating a structure of the mobile terminal in accordance with an embodiment of the present invention; and

FIG. 8 is a flow chart illustrating a method for determining and transmitting an access power signal to be sent form the mobile terminal to the BTS in accordance with an embodiment of the present invention.

### DETAILED DESCRIPTION OF EXEMPLARY EMBODIMENTS

Embodiments of the present invention will be described in detail herein below with reference to the accompanying drawings. In the drawings, the same or similar elements are denoted by the same reference numerals even though they are depicted in different drawings. In the following description, detailed descriptions of functions and configurations incorporated herein that are well known to those skilled in the art are omitted for clarity and conciseness.

The present invention provides a method for determining a transmission power of an access signal by additionally using base transceiver station (BTS) load information or a reception target signal to noise ratio (SNR) of a BTS in an open loop power control mode, thereby increasing the probability of successful initial access and minimizing a call setup time. After a system in accordance with an embodiment of the present invention is described, the configurations and operations of a BTS and a mobile terminal will be described.

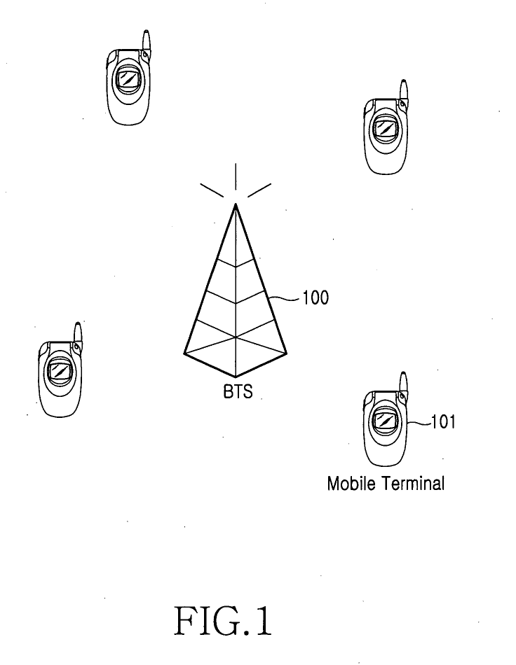

FIG. 1 illustrates a structure of the mobile communication system to which an embodiment of the present invention is applied.

In FIG. 1, a BTS 100 sends access parameter information through a broadcasting channel such that all mobile terminals within an associated cell can receive the information.

A mobile terminal 101 desiring to make an access attempt transmits an access signal at a power with a value obtained by subtracting a value of a received signal power from an ‘INIT_PWRs’ or ‘Open Loop Adjust’ value of access parameters sent by the BTS. ‘INIT_PWRs’ and ‘Open Loop Adjust’ values are shown in Equations (1) and (2).

When setting the ‘INIT_PWRs’ or ‘Open Loop Adjust’ value, the BTS sets a value based on the conventional open loop power control to a value obtained by considering a BTS load value or a target SNR of the BTS such that the BTS load value can be reflected according to time. This method can use a conventional message field without correction.

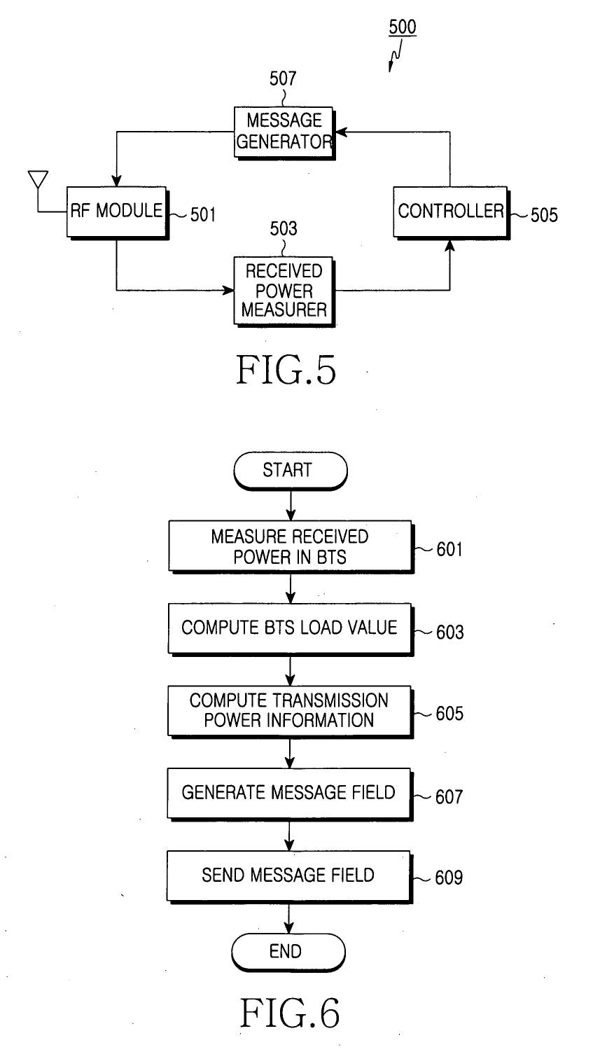

The BTS in accordance with an embodiment of the present invention will be described with reference to FIG. 5. FIG. 5 is a block diagram illustrating a structure of the BTS in accordance with an embodiment of the present invention. Some components of the BTS that are not directly associated with the present invention are omitted from FIG. 5.

In FIG. 5, the BTS 500 comprises a radio frequency (RF) module 501, a received power measurer 503, a controller 505, and a message generator 507. The BTS 500 can comprise an access parameter and a BTS load value in a message field to be transmitted, and can additionally comprise transmission power information in the message field, such that the mobile terminal can determine transmission power for access.

Now, details of the BTS 500 will be described. The RF module 501 up-converts baseband data to be transmitted as a RF signal after conversion to an intermediate frequency (IF) signal. The RF module 501 down-converts a signal of received data to a baseband frequency signal. The data comprises the message field configured by access parameter information and BTS load information in accordance with an embodiment of the present invention.

The received power measurer 503 measures total power received from mobile terminals outside the BTS such that a BTS load value is computed. The controller 505 computes the BTS load value using received power information sent from the received power measurer 503 and then sends the BTS load value to the message generator 507. The BTS load value can be computed as shown in Equation (3):
P_{BTS load}=P_{BTS receive}−P_{sensitivity} Equation (3)

In Equation (3), P_{BTS receive} denotes total power received by the BTS, and P_{sensitivity} denotes the minimum value of power capable of being received at a 1% frame error rate (FER) in the BTS.

In accordance with another embodiment of the present invention, the controller 505 sends, to the message generator 507, transmission power information as well as the BTS load value.

The message generator 507 inserts the BTS load value sent from the controller 505 into the message field, and generates a message. The message is sent to the mobile terminal through the RF module 501. In accordance with another embodiment of the present invention, the message generator 507 inserts the BTS load value and BTS transmission power information sent from the controller 505 into the message field and then sends the message.

A method for generating and transmitting a message field in the BTS 500 in accordance with an embodiment of the present invention will be described with reference to FIG. 6.

In FIG. 6, the received power measurer 503 measures the total received power of externally received signals and sends information about the measured power to the controller 505 in step 601. The controller 505 computes a BTS load value in step 603. The BTS load value is computed using Equation (3). When the BTS 500 additionally comprises transmission power information in a message field to be transmitted in accordance with another embodiment of the present invention, the controller 505 computes the transmission power information and notifies the message generator 507 of the computed transmission power information in step 605. However, when only the BTS load value is sent, step 605 is omitted.

The message generator 507 inserts an access parameter and the BTS load value sent from the controller 505 into the message field in step 607. Then, the RF module 501 sends the message field to the mobile terminal in step 609.

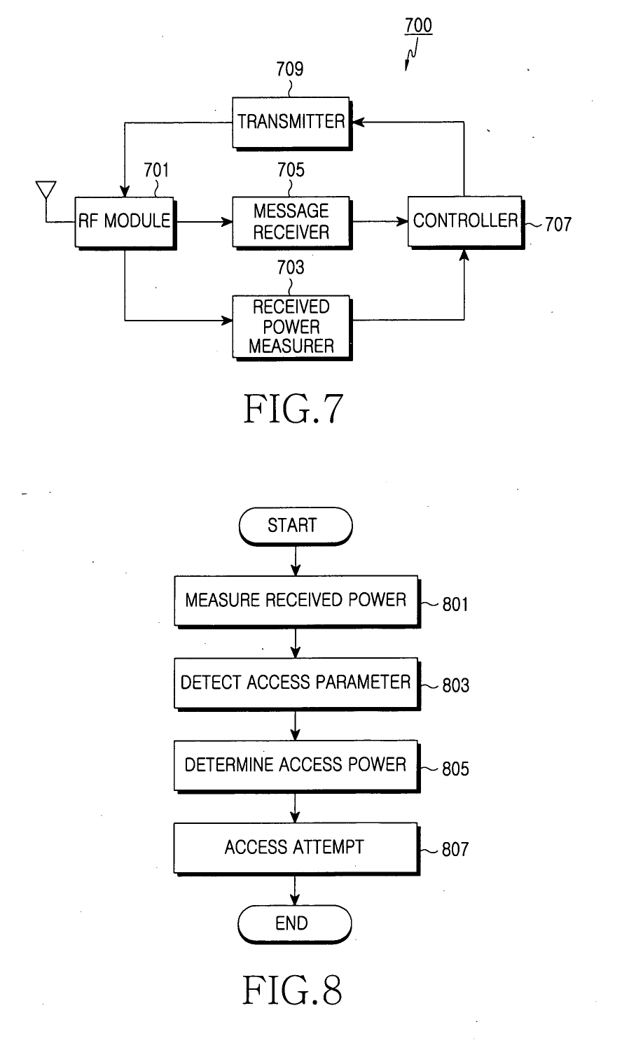

Next, the mobile terminal in accordance with an embodiment of the present invention will be described with reference to FIG. 7. FIG. 7 is a block diagram illustrating a structure of the mobile terminal in accordance with an embodiment of the present invention. Some components of the mobile terminal that are not directly associated with the present invention are omitted from FIG. 7. Accordingly, only essential components are illustrated in FIG. 7.

In FIG. 7, the mobile terminal 700 comprises a RF module 701, a received power measurer 703, a message receiver 705, a controller 707, and a transmitter 709.

The configuration of the mobile terminal 700 will be described in more detail. The RF module 701 up-converts baseband data to be transmitted to a RF signal after conversion to an intermediate frequency (IF) signal. The RF module 701 down-converts a signal of received data to a baseband frequency signal. The received data comprises a message field in accordance with an embodiment of the present invention.

The received power measurer 703 measures the received power of a high frequency band signal sent from the BTS, and sends information about the measured power to the controller 707. The received power measurer 703 is separate from the RF module 701 as illustrated in FIG. 7, but may be included in the RF module 701.

The message receiver 705 is a device for receiving a message from the BTS. The message receiver 705 detects an access parameter and a BTS load value included in a message field from a baseband signal sent by the RF module 701, and sends the detected access parameter and the detected BTS load value to the controller 707.

The controller 707 computes the transmission power of an access signal of the mobile terminal using information received from the received power measurer 703 and the message receiver 705. A method for determining the transmission power of an access signal in the controller 707 will be described in more detail. The transmitter 709 transmits data at the transmission power of the access signal computed in advance by the controller 707.

A method for determining the transmission power of an access signal in the mobile terminal 700 and transmitting data to the BTS will be described with reference to FIG. 8.

In FIG. 8, the received power measurer 703 of the mobile terminal 700 measures the power of a signal received from the BTS and sends information about the measured power to the controller 707 in step 801. The message receiver 705 detects a message field sent from the BTS and then sends the detected message field to the controller 707 in step 803. In an embodiment of the present invention, the message field can be configured by an access parameter and a BTS load value, and can additionally comprise BTS transmission power information. After identifying the access parameter, the BTS load value, and the power received from the BTS, the controller 707 determines the power of an access signal to be transmitted in step 805. After determining the transmission power for access, the mobile terminal 700 attempts access to the BTS in step 807.

Next, a method for determining the power of an access signal to be transmitted from the mobile terminal in the controller 707 will be described in more detail.

The controller 707 computes the transmission power of an access signal of the mobile terminal using Equation (4):
P_{access}=−P_{receive}+G Equation (4)

In Equation (4), P_{access} denotes a power value to be used when the mobile terminal transmits an access signal, and P_{receive} denotes a measured received power value when the mobile terminal receives a BTS signal, and G denotes a power value of ‘INIT_PWRs’ or ‘Open Loop Adjust’ of access parameters broadcast from the BTS. Measurement units for P_{access}, P_{receive}, and G are dBm. The power value of G is computed using Equation (5):
G=G_{open loop adjust}+P_{BTS load} Equation (5)

In Equation (5), G_{open loop adjust} denotes a fixed power compensation value used in the conventional open loop power control, and P_{BTS load} uses a rise over thermal (ROT) value or is a correction value obtained by considering a reception target SNR of the BTS. P_{BTS load} is computed using Equation (3). Here, all units use dBm. The ROT value is the ratio between power received from mobile terminals at the BTS and thermal noise.

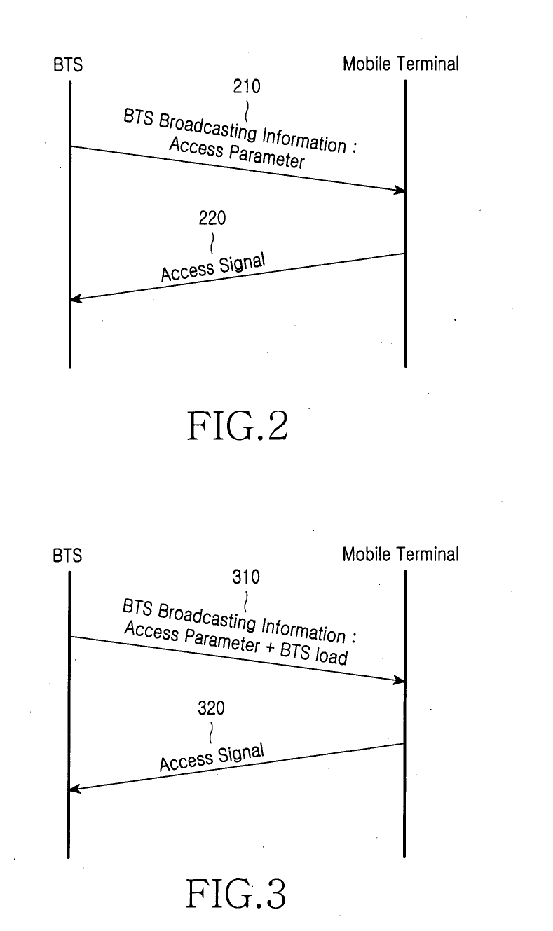

FIG. 2 is a signal flow diagram illustrating a method for determining transmission power of an access signal in the mobile terminal in accordance with an embodiment of the present invention.

Referring to FIG. 2, the BTS comprises an access parameter in broadcasting information and sends the broadcasting information to the mobile terminal in step 210. Then, the mobile terminal determines the transmission power at which an access signal is transmitted using Equation (4), and transmits the access signal at the determined transmission power in step 220.

When a BTS load value is included in a message field to be transmitted, two methods are used to set the access signal power in the mobile terminal.

The first method sets transmission power for access by using an ‘INIT_PWRs’ or ‘Open Loop Adjust’ value of the conventional access parameters and additionally using a BTS load value based on a target SNR of the BTS.

FIG. 3 is a signal flow diagram illustrating the first method for determining transmission power for access in the mobile terminal in accordance with an embodiment of the present invention.

Referring to FIG. 3, the BTS comprises access parameter information and BTS load information in BTS broadcasting information, and sends the BTS broadcasting information to the mobile terminal in step 310. Then, the mobile terminal computes the transmission power for access using the BTS broadcasting information in step 320. The transmission power for access is computed using Equation (6):
P_{access}=P_{receive}+G_{open loop adjust}+P_{BTS load} Equation (6)

In the second method, the BTS broadcasts a BTS transmission power value in addition to an ‘INIT_PWRs’ or ‘Open Loop Adjust’ value and BTS load information, and the mobile terminal estimates path loss between the BTS and the mobile terminal and sets transmission power for access using information broadcast from the BTS.

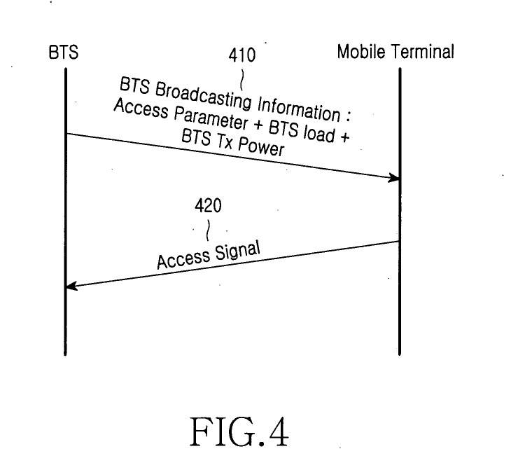

FIG. 4 is a signal flow diagram illustrating the second method for determining transmission power for access in the mobile terminal in accordance with an embodiment of the present invention.

Referring to FIG. 4, the BTS comprises access parameter information, BTS load information, and BTS transmission power information in BTS broadcasting information and sends the BTS broadcasting information to the mobile terminal in step 410. Then, the mobile terminal computes the transmission power for access using the BTS broadcasting information from the BTS in step 420. The transmission power for access is computed using Equation (7):
P_{access}=P_{receive}+G_{open loop adjust}+(P_{BTS TX}−P_{receive})+P_{BTS load} Equation (7)

In Equation (7), P_{BTS TX} denotes a BTS output power value.

In this method, the BTS sends transmission power information. Accordingly, the mobile terminal can accurately determine the path loss using the transmission power information sent from the BTS, as compared with the mobile terminal for measuring and detecting a BTS signal according to the conventional method.

In accordance with an embodiment of the present invention as described above, a BTS additionally broadcasts a BTS transmission power value and a mobile terminal estimates the path loss associated with the BTS using the BTS transmission power value and determines the transmission power for access on the basis of a value of the estimated path loss, such that the access power can be accurately set. In addition to the conventional method for compensating for only the path loss and determining the transmission power, the BTS additionally broadcasts a BTS load value or a transmission power value, and the mobile terminal additionally considers the BTS load value or the transmission power value after estimating the path loss, and determines the transmission power for access, such that the probability of successful initial access becomes high and a call setup time is minimized.

Although embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A mobile communication system for performing power control, comprising:
a base transceiver station (BTS) for generating and transmitting a message field comprising access parameter information and BTS load information within an area covered by the BTS; and
a mobile terminal for determining transmission power for access on a basis of power of a signal received from the BTS and the message field.

2. The mobile communication system of claim 1, wherein the BTS further comprises BTS transmission power information in the message field and transmits the message field.

3. The mobile communication system of claim 1, wherein the BTS comprises:
a received power measurer for measuring power received from all mobile terminals;
a controller for computing the BTS load information using the measured received power;
a message generator for generating the message field comprising the BTS load information; and
a transmitter for transmitting the message field to the mobile terminal.

4. The mobile communication system of claim 1, wherein the mobile terminal comprises:
a received power measurer for measuring received power of a signal transmitted from the BTS;
a message receiver for detecting the access parameter information and the BTS load information from the message field transmitted by the BTS;
a controller for computing transmission power for access on a basis of information sent from the received power measurer and the message receiver; and
a transmitter for accessing the BTS at the computed transmission power for access.

5. The mobile communication system of claim 4, wherein the controller considers BTS transmission power information and computes the transmission power for access.

6. A method for performing power control between a base transceiver station (BTS) and a mobile terminal in a mobile communication system, comprising the steps of:
(a) generating a message field comprising access parameter information and BTS load information and transmitting the message field from the BTS to the mobile terminal within an area covered by the BTS; and
(b) determining transmission power for access in the mobile terminal on a basis of power of a signal received from the BTS and the message field.

7. The method of claim 6, wherein the step (a) comprises the steps of:
measuring power received from all mobile terminals;
computing the BTS load information using the measured received power;
generating the message field comprising the BTS load information; and
transmitting the message field to the mobile terminal.

8. The method of claim 6, wherein the step (b) comprises the steps of:
measuring received power of a signal transmitted from the BTS;
detecting the access parameter information and the BTS load information from the message field transmitted by the BTS;
computing transmission power for access on a basis of information sent from a received power measurer and a message receiver; and
accessing the BTS at the computed transmission power.

9. A base transceiver station (BTS) for use in a mobile communication system for performing power control, comprising:
a received power measurer for measuring power received from all mobile terminals;
a controller for computing BTS load information using the measured received power;
a message generator for generating a message field comprising the BTS load information and an access parameter; and
a transmitter for transmitting the message field to a mobile terminal.

10. The BTS of claim 9, wherein the message generator generates the message field further comprising BTS transmission power information.

11. The BTS of claim 9, wherein the controller generates the BTS load information using a difference between a value of power received from all the mobile terminals and a minimum value of power capable of being received at a frame error rate preset by the BTS.

12. A method for transmitting power control information from a base transceiver station (BTS) in a mobile communication system, comprising the steps of:
measuring power received from all mobile terminals;
computing BTS load information using the measured received power;
generating a message field comprising the BTS load information and an access parameter; and
transmitting the message field to a mobile terminal.

13. The method of claim 12, wherein the message field further comprises BTS transmission power information.

14. The method of claim 12, wherein the step of computing the BTS load information comprises the step of:
generating the BTS load information using a difference between a value of power received from all the mobile terminals and a minimum value of power capable of being received at a frame error rate preset by the BTS.

15. A mobile terminal for use in a mobile communication system for performing power control, comprises:
a received power measurer for measuring received power of a signal transmitted from a base transceiver station (BTS);
a message receiver for detecting access parameter information and BTS load information from a message transmitted by the BTS;
a controller for computing transmission power for access on a basis of information sent from the received power measurer and the message receiver; and
a transmitter for accessing the BTS at the computed transmission power for access.

16. The mobile terminal of claim 15, wherein the message receiver further detects BTS transmission power information from a field of the message.

17. The mobile terminal of claim 16, wherein the controller considers the BTS transmission power information and computes the transmission power for access.

18. A method for determining transmission power for access in a mobile terminal of a mobile communication system for performing power control, comprising the steps of:
measuring received power of a signal transmitted from a base transceiver station (BTS);
detecting access parameter information and BTS information from data transmitted by the BTS; and
computing transmission power for access on a basis of the received power, the parameter information, and BTS load information and performing transmission at the computed transmission power for access.

19. The method of claim 18, wherein the BTS information comprises the BTS load information.

20. The method of claim 19, wherein the BTS information further comprises BTS transmission power information.
